(19) United States
(12) Patent Application Publication
(10) Pub. No.: US 2010/0309232 A1
(43) Pub. Date: Dec. 9, 2010

(54) CONTROL METHOD FOR IMAGE DISPLAY APPARATUS

(75) Inventors: Ayumu Wada, Ebina-shi (JP); Kazuhiko Murayama, Atsugi-shi (JP); Naoto Abe, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/786,614

(22) Filed: May 25, 2010

(30) Foreign Application Priority Data
Jun. 8, 2009 (JP) 2009-137160
Jan. 20, 2010 (JP) 2010-009676

(51) Int. Cl. G09G 5/10; G09G 3/20

(52) U.S. Cl. 345/690; 345/55

(57) ABSTRACT

A control method for an image display apparatus includes the steps of outputting a selection potential to a row wiring to be driven; and generating a modulation pulse based on a value of image data, and outputting the modulation pulse to a column wiring. The modulation pulse generating step generates, in a range of Imin≦I≦I1, a trapezoidal shape pulse as the modulation pulse, and makes the pulse height of the trapezoidal shape pulse larger in accordance with the increasing of I; and makes, in the range of I1<I≦I2, the pulse width of the trapezoidal shape pulse longer in accordance with the increasing of I. Here, I is a value of the image data, Imin is a minimum value of I, Imax is a maximum value of I, and Imin<I1<I2≦Imax.

### BACKGROUND OF THE INVENTION

1. Field of the Invention

The present invention relates to a control method for an image display apparatus.

2. Description of the Related Art

As flat type image display apparatuses, there have been known a display apparatus using an electron-emitting device (i.e., electron beam display apparatus), a liquid crystal display apparatus, a plasma display apparatus, an organic electroluminescence display apparatus, and so on. Such kinds of flat type image display apparatuses are each provided with a display panel (matrix panel) on which a multitude of display elements are arranged in a matrix form, and a drive circuit for driving the display elements. In general, a modulation signal (modulation pulse), which has been modulated in accordance with an image signal, is supplied to a display element which becomes an object to be driven. As modulation methods, there have been known pulse width modulation, amplitude (or pulse height) modulation), and so on.

Japanese patent application laid-open No. 2003-173159 discloses a modulation method in which pulse width modulation and amplitude modulation are combined with each other. Moreover, the Japanese patent application laid-open No. 2003-173159 discloses a modulation circuit which makes the rising edge and the falling edge of a pulse waveform into stepwise shapes, respectively. Japanese patent application laid-open No. 2003-228317 discloses controlling a scan drive circuit and a modulation drive circuit in accordance with image data inputted in such a manner that the scan time of a row wiring corresponding to a portion of the data with a large image data level becomes long and the scan time of a row wiring corresponding to a portion thereof with a small image data level becomes short.

### SUMMARY OF THE INVENTION

It is desired to further suppress voltage fluctuations at the time of waveform transition thereby to achieve stable driving in accordance with the increased resolution and the increased driving speed of a display panel. In a matrix driving type image display apparatus such as in particular an electron beam display apparatus, there has been a problem that the volume of the matrix panel is large and a drive voltage therefor is also large, so at the time of application of a modulation pulse waveform, voltage fluctuations might occur in other wirings due to high frequency components, thus causing the brightness or luminance of the panel to change. In particular, in a low luminance range, the modulation pulse waveform is small, so the rate of a brightness or luminance change due to voltage fluctuations is relatively high as compared with a high luminance range. For this reason, it is desired to make high frequency components included in the modulation pulse waveform in the low luminance range as small as possible.

The present invention provides a technique which makes, at the time of application of a modulation pulse waveform on a wiring, voltage fluctuations of other wirings due to high frequency components in the low luminance range small thereby to suppress a luminance change due to the voltage fluctuations.

The present invention provides a control method for an image display apparatus with a display panel in which a plurality of display elements are arranged in an matrix arrangement using a plurality of column wirings and a plurality of row wirings, the control method including the steps of: outputting a selection potential to a row wiring to be driven; and generating a modulation pulse based on a value of image data, and outputting the modulation pulse to the column wiring, wherein, when I is a value of the image data, Imin is a minimum value of I, Imax is a maximum value of I, and Imin<I1<I2≦Imax, the step of generating and outputting the modulation pulse generates, in a range of Imin≦I≦I1, a trapezoidal shape pulse as the modulation pulse, and makes the pulse height of the trapezoidal shape pulse larger in accordance with the increasing of the value I; and makes, in the range of I1<I≦I2, the pulse width of the trapezoidal shape pulse longer in accordance with the increasing of the value I.

According to the present invention, in the low luminance range, at the time of application of a modulation pulse waveform on a wiring, voltage fluctuations of other wirings due to high frequency components can be decreased, thereby making it possible to suppress a luminance change due to the voltage fluctuations.

Further features of the present invention will become apparent from the following description of exemplary embodiments with reference to the attached drawings.

### BRIEF DESCRIPTION OF THE DRAWINGS

FIG. 1 is a schematic diagram of a gradation control method for a modulation pulse waveform according to the present invention.

FIG. 2A through FIG. 2C are examples of the gradation control method for a modulation pulse waveform according to the present invention.

FIG. 3A and FIG. 3B are examples of the gradation control method for a modulation pulse waveform according to the present invention.

FIG. 4A is a view showing the construction of an image display apparatus, and FIG. 4B is a view showing the construction of a modulation circuit.

FIG. 5A is a view showing the construction of a logical circuit of a modulation circuit, and FIG. 5B is a view showing the construction of an output circuit.

FIG. 6A is a view showing a first embodiment of a reference waveform generation circuit, and FIG. 6B is a view showing a second embodiment of the reference waveform generation circuit.

FIG. 7A is a view showing a generation circuit for a rising slope waveform, and FIG. 7B is a view showing a generation circuit for a falling slope waveform.

FIG. 8A through FIG. 8D are timing charts for the output circuit.

FIG. 9A through FIG. 9D are logical tables for the output circuit.

FIG. 10A through FIG. 10F are explanatory views for explaining independent RGB adjustments.

FIG. 11 is a block diagram in which arranged the switches SH, SL for outputting a power supply voltage are provided.

FIG. 12 is a view showing variable control on a scan time according to a third embodiment.

FIG. 13A and FIG. 13B are explanatory views, respectively, for a modulation pulse and a selection potential.

### DESCRIPTION OF THE EMBODIMENTS

An image display apparatus of the present invention is an image display apparatus which has a display panel (matrix panel) with a plurality of display elements being arranged in a matrix fashion by means of a plurality of column wirings and a plurality of row wirings, and includes, for example, an electron beam display apparatus, a plasma display apparatus, an organic electroluminescence display apparatus, and so on. In particular, the electron beam display apparatus is a preferable form to which the present invention is applied, from the point of view that the wiring capacity of the matrix panel and the volume of elements thereof are large, and the drive voltage supplied to the elements is also large. In the electron beam display apparatus, a field emission type electron-emitting device, a MIM type electron-emitting device, and a cold cathode device (electron-emitting device) such as a surface conduction type electron-emitting device, etc., are used as a display element.

### First Embodiment

In general, an image display apparatus is provided with a scan circuit and a modulation circuit, as a driving unit for driving a display panel. The scan circuit is a circuit which outputs a selection potential to one or more row wirings to be driven, and the modulation circuit is a circuit that generates a modulation pulse based on image data, and outputs the modulation pulse to column wirings. The modulation circuit of the image display apparatus of the present invention generates a waveform (source waveform) of the modulation pulse by suitably combining a first waveform rising in a slope shape, a second waveform specifying the height of the pulse (pulse height), and a third waveform falling in a slope shape. The modulation circuit has a logical circuit that generates a control signal for waveform control based on the image data, and can freely control the timing at which the first waveform, the second waveform, and the third waveform are switched over therebetween, or the pulse height of the second waveform, etc., by means of this control signal.

In the following, specific reference will be made to an output method of a modulation pulse which can be outputted by the modulation circuit of this embodiment.

The modulation circuit generates a modulation pulse of a trapezoidal shape or a substantially trapezoidal shape based on the value I of image data (I being an integer which is equal to or larger than a minimum value Imin and is equal to or less than a maximum value Imax). Specifically, the modulation circuit (1) increases the pulse height of the trapezoidal shape pulse in accordance with the increasing of value I in the range of Imin≦I≦I1, and (2) increases the pulse width of the trapezoidal shape pulse in accordance with the increasing of value I in the range of I1<I≦I2. Here, Imin<I1<I2≦Imax.

In the control of (1) above, the modulation circuit controls the waveform of the trapezoidal shape pulse in such a manner that the pulse is caused to rise in a slope shape up to a pulse height h(I), then the pulse height h(I) is maintained during a period of time t1, and finally the pulse is caused to fall in a slope shape. Here, note that h(I) is a value which is larger than 0 and increases in accordance with the increasing of I. Although h(I) is typically a linear function of I, it is not limited to such a linear function but may be any other function if it increases in a monotonous manner. The period of time t1 may be a fixed value, or may also be a function of I. By this control, it is possible to reduce high frequency components of the modulation pulse in a low luminance range can be reduced as compared with the use of a rectangular shape pulse and a triangular shape pulse.

In the control of (2) above, the modulation circuit controls the waveform of the trapezoidal shape pulse in such a manner that the pulse is caused to rise in a slope shape to a pulse height h(I1), then the pulse height h(I1) is maintained during a period of time t1+f(I), and finally the pulse is caused to fall in a slope shape. Here, note that f(I) is a value that is larger than 0 and increases in accordance with the increasing of I. Although f(I) is typically a linear function of I, it is not limited to such a linear function but may be any other function if it increases in a monotonous manner. The control of (2) above is a control in which the pulse width (the length of a flat portion of the trapezoidal shape pulse) is extended in accordance with the increasing of the image data while keeping the value of the pulse height constant. By this control, it is possible to decrease the number of steps of the value of the pulse height as compared with the case in which all the steps of the gradation are controlled by the pulse height of the trapezoidal shape pulse.

It is also desirable to further add the following controls (3) through (6) to the controls of (1) and (2) above where appropriate.

(3) In the range of I2<I≦I3 (where I2<I3≦Imax)

The modulation circuit generates, as the modulation pulse, a substantially trapezoidal shape pulse which rises in a slope shape up to a pulse height h1, is maintained at the pulse height h1 during the period of time t1, falls in a slope shape down to a pulse height h2, is maintained at the pulse height h2 during a period of time t2, and falls in a slope shape. The period of time t2 during which the substantially trapezoidal shape pulse is maintained is made longer in accordance with the increasing value I. Here, note that h1 corresponds to the value of the pulse height in the case of I=I2, and t1 corresponds to the top side length of the trapezoidal shape pulse in the case of I=I2. t2 is a value which is larger than 0 and increases in accordance with the increasing of I.

(4) In the range of I3<I≦I4 (where I3<I4≦Imax)

The modulation circuit generates, as the modulation pulse, a substantially trapezoidal shape pulse which rises in a slope shape up to the pulse height h1, is maintained at the pulse height h1 during the period of time t1, falls in a slope shape down to the pulse height h2, is maintained at the pulse height h2 during the period of time t2, falls in a slope shape down to a pulse height h3, is maintained at the pulse height h3 during a period of time t3, and falls in a slope shape. The period of time t3 during which the substantially trapezoidal shape pulse is maintained is made longer in accordance with the increasing of the value I. Here, t3 is a value which is larger than 0 and increases in accordance with the increasing of I.

(5) In the range of I2<I≦I5 (where I2<I5≦Imax)

The modulation circuit generates, as the modulation pulse, a second trapezoidal shape pulse which is larger than the trapezoidal shape pulse corresponding to I=I2. Then, the value of the pulse height of the second trapezoidal shape pulse is made larger in accordance with the increasing of the value I.

(6) In the range of I5<I≦I6 (where I5<I6≦Imax)

The modulation circuit makes the pulse width of the second trapezoidal shape pulse longer in accordance with the increasing of the value I.

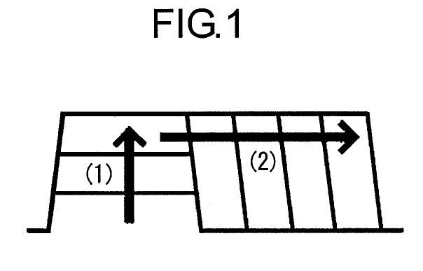

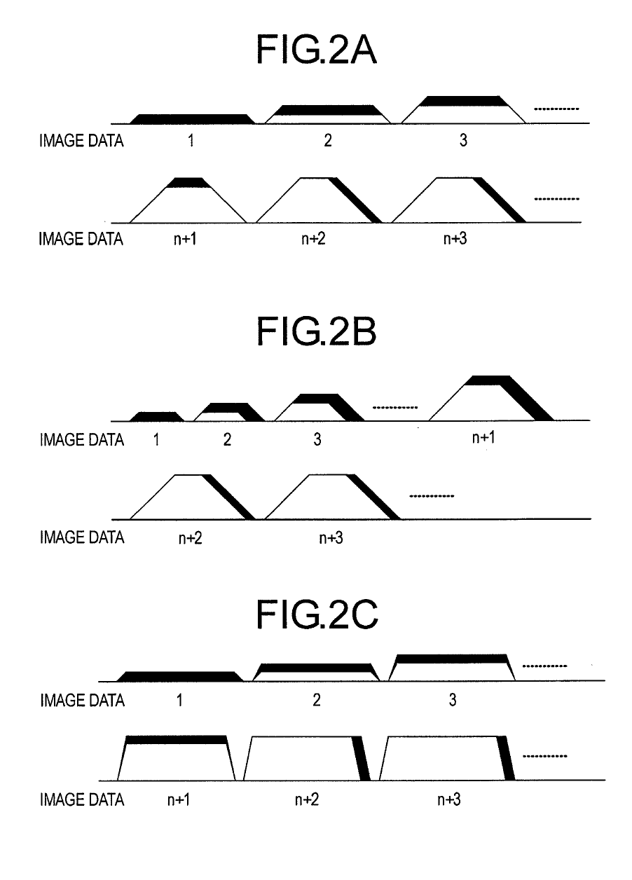

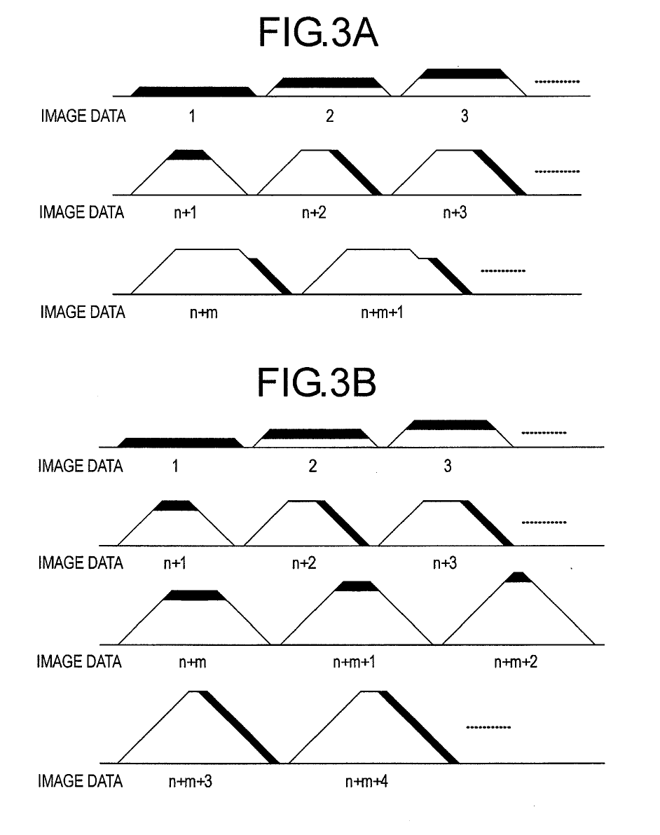

FIG. 1 shows a schematic diagram of a gradation control method for a modulation pulse waveform according to the present invention. FIG. 1 shows in (1) that gradation control in the low luminance range is carried out by increasing the value of the pulse height of the trapezoidal waveform, and in (2) that gradation control in the high luminance range is carried out by increasing the pulse width, while keeping constant the value of the pulse height of the trapezoidal waveform. FIGS. 2A through 2C and FIGS. 3A, 3B show examples of the gradation control method for a modulation pulse waveform according to the present invention. Here, note that a black portion in each pulse waveform indicates an increment from a pulse waveform in a graduation step one step before the present step.

FIGS. 2A through 2C show examples of Imin=1 and I1=n+1.

FIG. 2A shows that the gradation in a low luminance range (image data 1 to n+1) is formed by gradually making larger the pulse height of a trapezoidal shape pulse while keeping constant the lower side length of the trapezoidal shape pulse. In a high luminance range (image data from n+2 onward), the gradation is formed by gradually making longer the pulse width of the trapezoidal shape pulse while keeping constant the pulse height of the trapezoidal shape pulse.

FIG. 2B shows that the gradation in a low luminance range (image data 1 to n+1) is formed by gradually making larger the pulse height of a trapezoidal shape pulse while keeping constant the top side length of the trapezoidal shape pulse. In a high luminance range (image data from n+2 onward), the gradation is formed by gradually making longer the pulse width of the trapezoidal shape pulse while keeping constant the pulse height of the trapezoidal shape pulse.

Although in the examples of FIG. 2A and FIG. 2B, the inclinations of the rising and falling of a slope are set to be constant for all the steps of gradation, they are not necessarily limited to this and the inclinations may be changed for every step of gradation. FIG. 2C shows an example in which the inclinations are changed for every step of gradation. In addition, although in the example of FIG. 2A, the lower side length of the trapezoidal shape pulse is fixed in the low luminance range (image data 1 to n+1), and in the example of FIG. 2B, the upper side length of the trapezoidal shape pulse is fixed in the low luminance range (image data 1 to n+1), they are not necessarily limited to these, and the upper side length and the lower side length may be changed for every step of gradation.

FIG. 3A shows that the gradation in a low luminance range (image data 1 to n+1) is formed according to the same procedure as that in FIG. 2A. In a first high luminance range (image data n+2 to n+m−1), the gradation is formed by gradually making longer the pulse width of a trapezoidal shape pulse while keeping constant the pulse height of the trapezoidal shape pulse. Moreover, in a second high luminance range (image data from n+m onward), the gradation is formed by gradually making longer the pulse width of a trapezoidal shape pulse while keeping constant the pulse height of the trapezoidal shape pulse which is lower than that thereof in the first high luminance range (image data n+2 to n+m−1).

FIG. 3B shows that the gradation in the low luminance range (image data 1 to n+1) is formed according to the same procedure as that in FIG. 2A. In the first high luminance range (image data n+2 to n+m−1), the gradation is formed by gradually making longer the pulse width of a trapezoidal shape pulse while keeping constant the pulse height of the trapezoidal shape pulse. In the second high luminance range (image data n+m to n+m+2), the gradation is formed by gradually making larger the pulse height of a trapezoidal shape pulse. In a third high luminance range (image data from n+m+3 onward), the gradation is formed by gradually making longer the pulse width of the trapezoidal shape pulse while keeping constant the pulse height of the trapezoidal shape pulse.

Although in the example of FIG. 3A, the control of making low the value of the pulse height is performed only once, it is not necessarily limited to this, but the value of the pulse height may be made low a plurality of times. Although in the example of FIG. 3B, the control of gradually making larger the pulse height of a trapezoidal shape pulse and the control of gradually making longer the pulse width of a trapezoidal shape pulse while keeping constant the pulse height of the trapezoidal shape pulse are combined with each other two times, such a combination is not necessarily limited to this but may be made two or more times. In addition, it is also desirable to change the value of the pulse height for each color in order to correct a difference in the luminous efficiency of fluorescent substances, as will be described later.

Next, specific reference will be made to the construction and control method of the above-mentioned image display apparatus for outputting a modulation pulse.

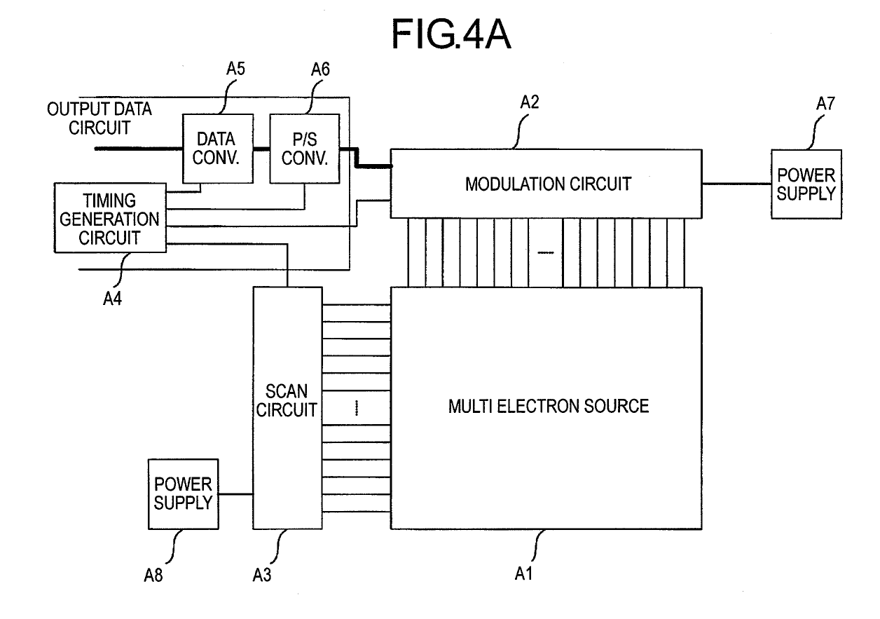

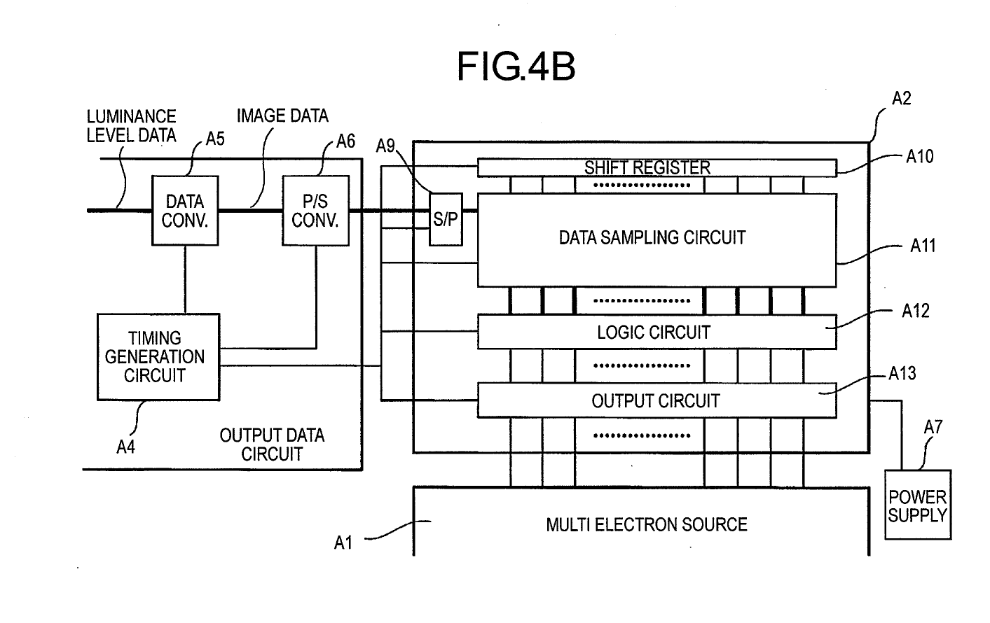

FIG. 4A is a block diagram showing the construction of the image display apparatus of the present invention. The image display apparatus is schematically provided with a multi electron source A1 as a display panel (image display unit), and a drive apparatus that drives the multi electron source A1.

The drive apparatus is composed of an output data circuit, a modulation circuit A2, a scan circuit A3, a modulation power supply circuit A7, and a scanning power source circuit A8. The output data circuit is provided with a timing generation circuit A4, a data conversion circuit A5, a parallel/serial conversion circuit A6, and so on.

The multi electron source A1 is provided with a plurality of electron-emitting devices, a plurality of row wirings, and a plurality of column wirings, and an electron-emitting device is formed at each of intersection parts of the row wirings and the column wirings. When a selection potential is supplied to a row wiring and a modulation pulse is supplied to a column wiring, a drive voltage in the form of a potential difference between the selection potential and the modulation pulse is applied to an electron-emitting device at an intersection part therebetween. By controlling the time of application and the value of this drive voltage in an appropriate manner, a desired element can be made to emit light at a desired brightness or luminance.

The modulation circuit A2 is connected to the column wirings of the multi electron source A1. This modulation circuit A2 is a circuit that generates a modulation signal (modulation pulse) based on image data supplied from the output data circuit, and outputs the modulation signal to each of the column wirings of the multi electron source A1.

The modulation power supply circuit A7 is a power supply circuit that is constructed in such a manner as to be able to output a plurality of voltage values. The modulation power supply circuit A7 is not only a power source for circuit operation of the modulation circuit A2, but also a power source for specifying the voltage value of the modulation pulse outputted from the modulation circuit A2. Although the modulation power supply circuit A7 is in general a voltage source circuit, it is not necessarily limited to this.

The scan circuit A3 is connected to the row wirings of the multi electron source A1. The scan circuit A3 is a circuit for selecting, from among all the row wirings, one or several row wirings which are to be driven, and changing a row wiring to be selected in a sequential manner. In general, line sequential scanning of making line selection sequentially line by line is performed, but scanning is not limited to this. The scan circuit A3 can also make skip scanning (interlaced scanning) or a selection of multiple lines, or a surface or planar selection (multiline scan). The scan circuit A3 supplies a selection potential to one or plural row wirings to be driven (selection line(s)), and supplies a non-selection potential to the other row wirings (non-selection lines).

The scanning power source circuit A8 is a power supply circuit that outputs a plurality of voltage values (selection potential, non-selection potential). Although the scanning power source circuit A8 is in general a voltage source circuit, it is not necessarily limited to this.

The timing generation circuit A4 is a circuit that generates timing signals as control data to control the circuit timings of the modulation circuit A2, the scan circuit A3, the data conversion circuit A5, and the parallel/serial conversion circuit A6, respectively.

The data conversion circuit A5 is a circuit that converts inputted luminance level data into image data suitable for the modulation circuit A2 and the multi electron source A1. For example, the data conversion circuit A5 can perform signal processing, such as inverse gamma conversion, luminance correction, color correction, resolution conversion, maximum value adjustment (limiter), and so on, with respect to the luminance level data.

The parallel/serial conversion circuit A6 is a circuit that converts image data outputted from the data conversion circuit A5 from parallel data into serial data, and outputs it to the modulation circuit A2.

FIG. 4B is a block diagram showing the circuit arrangement of the modulation circuit A2. The modulation circuit A2 is composed of a serial/parallel conversion circuit A9, a shift register A10, a data sampling circuit A11, a logic circuit A12, and an output circuit A13.

In the following, the operation of the modulation circuit A2 in this embodiment will be explained.

The image data outputted from the output data circuit is converted into parallel data by the serial/parallel conversion circuit A9. The image data thus converted into the parallel data is stored in the data sampling circuit A11 by means of the shift register A10 in a sequential or successive manner.

Image data corresponding to the number of horizontal pixels of the multi electron source A1 (hereinafter, the number of horizontal pixels being set to M) is stored in the data sampling circuit A11. After that, based on the image data for each of the pixels stored in the data sampling circuit A11, the logic circuit A12 generates a control signal (control sequence) of the output circuit A13, and sends out it to the output circuit A13.

The output circuit A13 generates a modulation pulse based on the control signal (control sequence), and outputs the modulation pulse to the column wiring of the multi electron source A1.

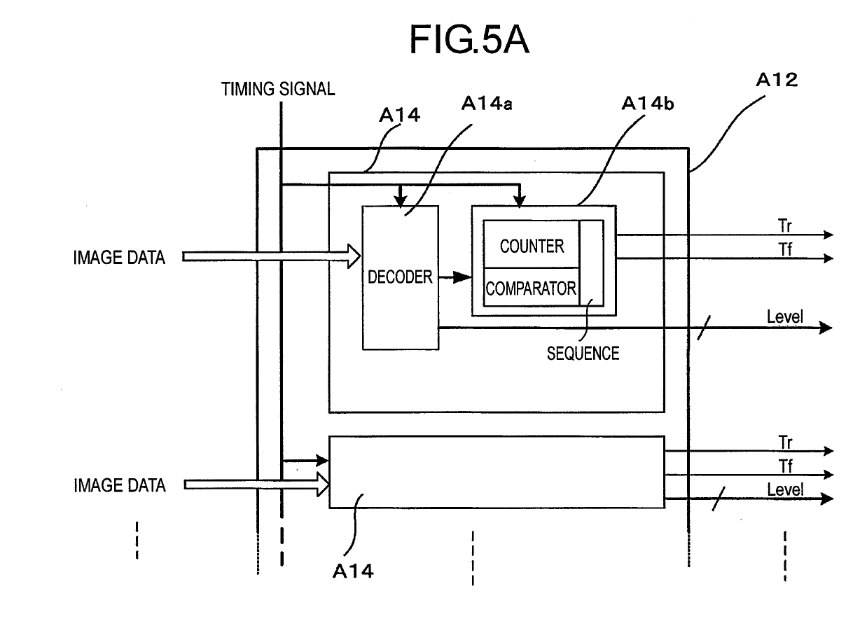

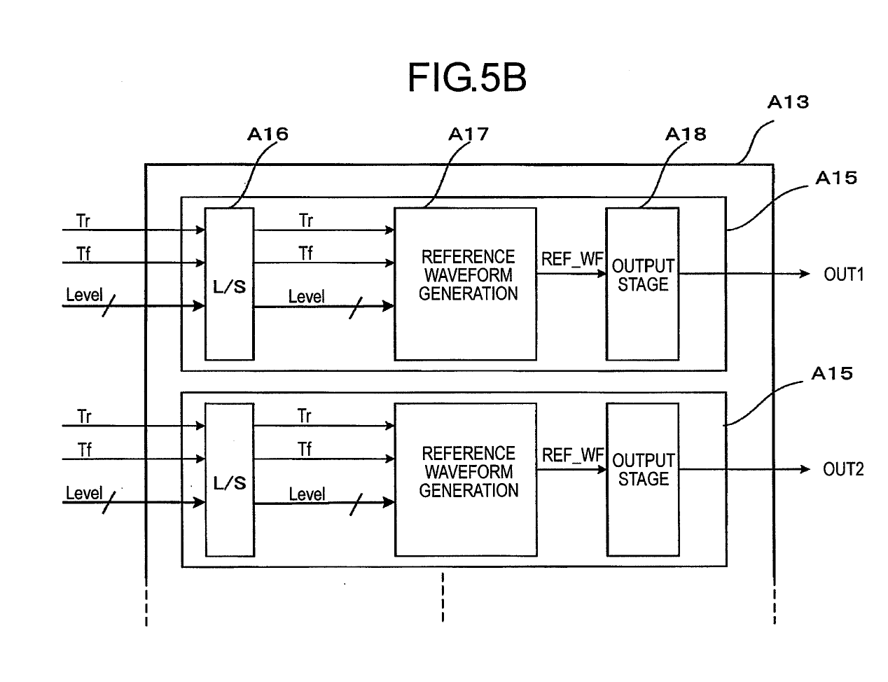

FIG. 5A is a block diagram showing the circuit arrangement of the logic circuit A12 of the modulation circuit.

The logic circuit A12 is provided with M pieces of logic circuits A14. Each of the logic circuits A14 corresponds to each pixel. Hereinafter, a specific construction and operation of the logic circuits A14 will be explained by taking as an example a logic circuit A14 for one pixel.

Each logic circuit A14 is provided with a decoder A14a and a sequence generation circuit A14b. Image data sampled by the data sampling circuit A11 is inputted to the decoder A14a. The decoder A14a generates control data for rising and falling timings of the modulation pulse from the image data and a timing signal from the output data circuit. The control data is inputted to the sequence generation circuit A14b, where it is used as data for a comparator. In addition, the decoder A14a generates, from the image data and the timing signal, a control signal Level for specifying an output level of the modulation pulse. The control signal Level is inputted to the output circuit A13.

The sequence generation circuit A14b counts the number of clocks based on a clock signal supplied as a timing signal. The comparator in the sequence generation circuit A14b compares the counted value with the control data for rising and falling timings. Then, based on the value of the comparator, a control signal Tr for specifying the rising timing of the modulation pulse, and a control signal Tf for specifying the falling timing of the modulation pulse are generated. The control signals Tr, Tf are inputted to the output circuit A13.

FIG. 5B is a block diagram showing the circuit arrangement of the output circuit A13 of the modulation circuit.

The output circuit A13 is provided with M pieces of output circuits A15. Each of the output circuits A15 corresponds to each pixel (each column wiring). Hereinafter, a specific construction and operation of the output circuits A15 will be explained by taking as an example an output circuit A15 for one pixel.

Each output circuit A15 is composed of a level shift circuit A16, a reference waveform generation circuit A17, and an output stage A18.

The control signals Tr, Tf, Level sent out from a logic circuit A14 are inputted to a corresponding output circuit A15. The level shift circuit A16 converts the voltages of the control signals Tr, Tf, Level from their logic levels into operating voltage levels of the output circuit A15. The control signals Tr, Tf, Level outputted from the level shift circuit A16 are inputted to the reference waveform generation circuit A17.

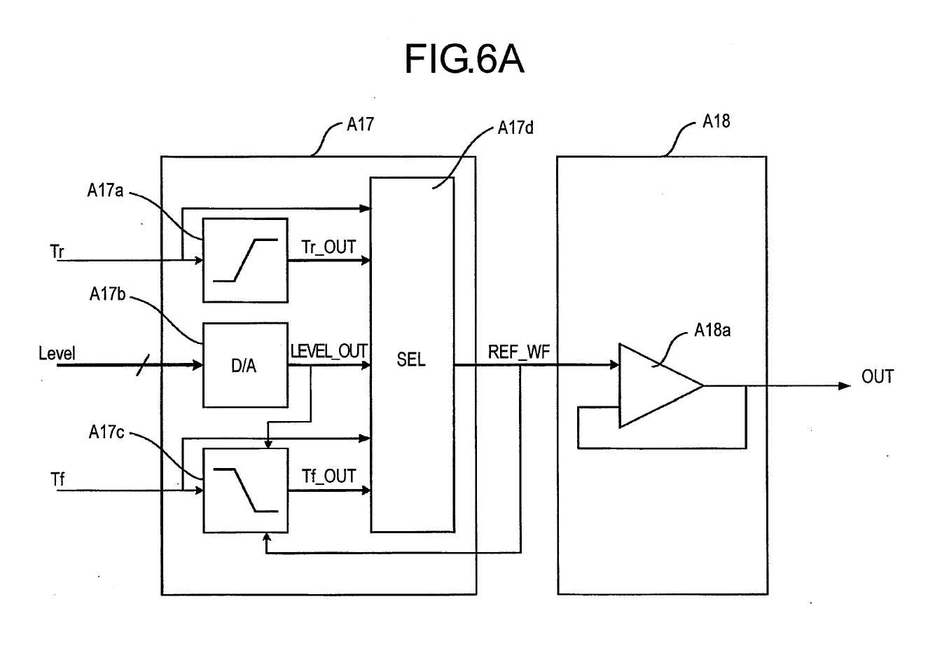

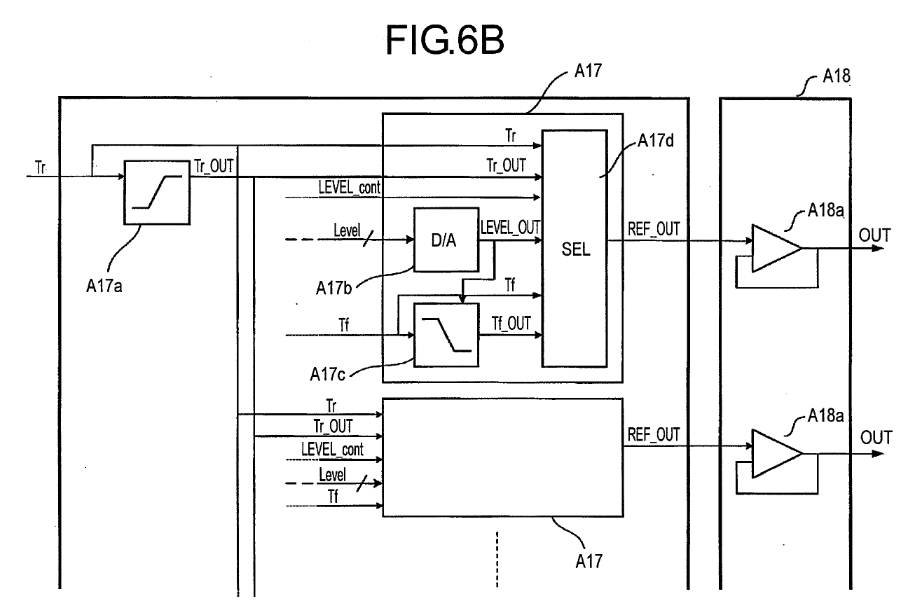

FIG. 6A is a block diagram showing the circuit arrangement of each reference wave generation circuit A17. Each reference waveform generation circuit A17 is composed of a rising reference waveform generation part A17a, an output level generation part A17b, a falling reference waveform generation part A17c, and a waveform switching part A17d.

In this embodiment, the rising reference waveform generation part A17a, the output level generation part A17b, and the falling reference waveform generation part A17c correspond to a first waveform generation part of the present invention, a second waveform generation part, and a third waveform generation part, respectively. In addition, the waveform switching part A17d corresponds to a waveform switching part of the present invention.

Next, a rising waveform generation operation will be explained.

The control signal Tr having been subjected to a level shift is inputted to a corresponding rising reference waveform generation part A17a. When the control signal Tr is inputted, the rising reference waveform generation part A17a generates and outputs a rising slope waveform with a predetermined inclination. As the rising slope waveform (first waveform), any waveform may be used as long as it is a waveform that rises gently in a slope shape. A waveform increasing in a monotonous manner is preferable, and a waveform with a fixed inclination or slope is more preferable. This is because gradation control becomes easy.

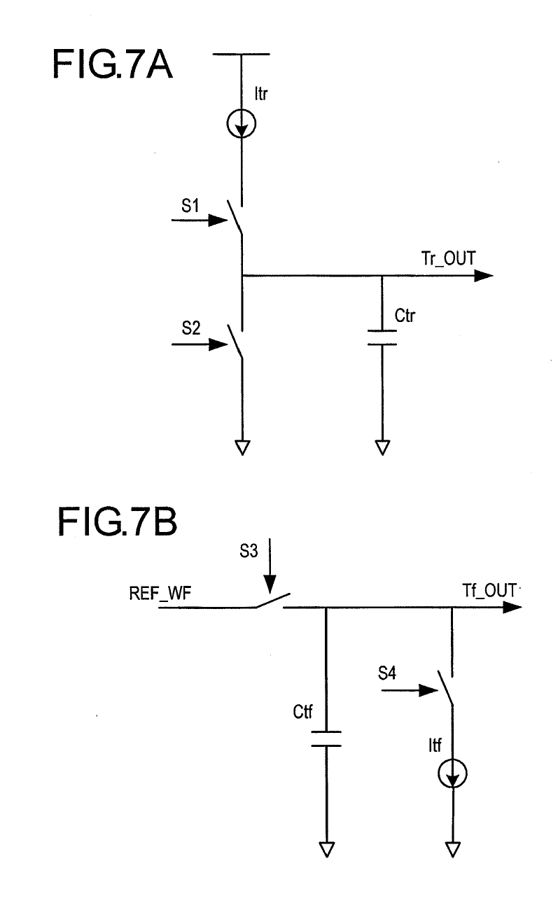

FIG. 7A is an example of a circuit arrangement for generating a rising slope waveform. This circuit is composed of switches S1, S2, a current source Itr, and a capacitance Ctr.

When the control signal Tr is in an on state (high), the switch S1 is turned into an on state, and the switch S2 is turned into an off state. Due to the changing of the switch S1 to an on state, a fixed current flows into the capacitance Ctr from the current source Itr, so that electric charge is charged into the capacitance Ctr. By this operation, an output voltage Tr_OUT becomes a waveform with a fixed inclination. Here, note that in cases where the inclination of a slope waveform is changed according to the gradation, two or more kinds of such circuits need only be provided.

When the control signal Tr is changed into an off state (low), the switch S1 is turned into an off state, and the switch S2 is turned into an on state. By this operation, the electric charge charged into the capacitance Ctr is discharged so that the output voltage Tr_OUT is set to 0 V. Here, note that in this example, a current source may be connected to the switch S2 side so as to be directed toward ground.

Next, an output level generation operation will be explained.

The control signal Level having been subjected to a level shift is inputted to a corresponding output level generation part A17b. The output level generation part A17b carries out digital/analog conversion of the control signal Level thereby to output a voltage level signal LEVEL_OUT of a fixed voltage. This voltage level signal LEVEL_OUT is a waveform (second waveform) for specifying the value of the pulse height of the modulation pulse.

Next, a falling waveform generation operation will be explained.

The control signal Tf having been subjected to a level shift is inputted to a corresponding falling reference waveform generation part A17c. The falling reference waveform generation part A17c always receives the voltage of a reference waveform REF_WF outputted from the waveform switching part A17d. The reason why the falling reference waveform generation part A17c always receives the voltage of the reference waveform REF_WF is for generating a falling waveform from a voltage level outputted from the waveform switching part A17d. That is, when the control signal Tf is inputted, the falling reference waveform generation part A17c generates a falling slope waveform with a predetermined inclination from the voltage value of the reference waveform REF_WF thereby to output an output voltage Tf_OUT.

As the falling slope waveform (third waveform), any waveform may be used as long as it is a waveform that falls gently in a slope shape. A waveform decreasing in a monotonous manner is preferable, and a waveform with a fixed inclination or slope is more preferable. This is because gradation control becomes easy.

FIG. 7B is an example of a circuit arrangement for generating a falling slope waveform. This circuit is composed of switches S3, S4, a current source Itf, and a capacitance Ctf.

When the control signal Tf is in an on state (high), the switch S3 is turned into an on state, and the switch S4 is turned into an off state. For this reason, the same voltage as that of the reference waveform REF_WF is inputted, so that the capacitance Ctf is thereby charged.

When the control signal Tf is changed into an off state (low), the switch S3 is turned into an off state, and the switch S4 is turned into an on state. By this operation, the output voltage Tf_OUT becomes a falling waveform with a fixed inclination from the voltage of the reference waveform REF_WF immediately before the start of falling, and falls to a ground level. Here, note that in cases where the inclination of a slope waveform is changed according to the gradation, two or more kinds of such circuits need only be provided.

Next, a waveform switching operation and an output waveform operation will be explained.

By changing the reference waveforms (output voltages) of the rising reference waveform generation part A17a, the output level generation part A17b and the falling reference waveform generation part A17c based on the control signals Tr, Tf, the waveform switching part A17d generates the reference waveform REF_WF and outputs it to the output stage A18. Specifically, the waveform switching part A17d selects the output voltage Tr_OUT of the rising reference waveform generation part A17a when the control signal Tr is high, and selects the output voltage LEVEL_OUT of the output level generation part A17b when the control signal Tr is low.

In addition, the waveform switching part A17d gives priority to the logic of the control signal Tr when the control signal Tf is high, and selects the output voltage Tf_OUT of the falling reference waveform generation part A17c when the control signal Tf is low.

By making reference to the output wave REF_WF from the waveform switching part A17d, the output stage A18 generates a modulation pulse having the same or similar waveform. The modulation pulse OUT is outputted to the column wirings of the multi electron source A1. It is preferable that the output stage A18 have a unity gain buffer construction using an operational amplifier A18a, as shown in FIG. 6A. In addition, an amplification stage construction of operational amplifiers may be adopted as the output stage.

### First Operation Example

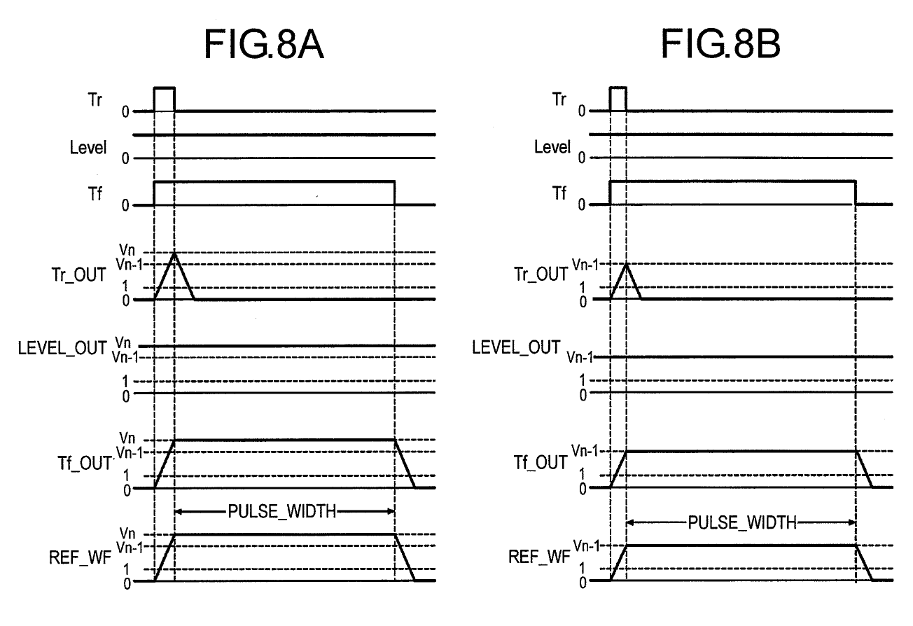

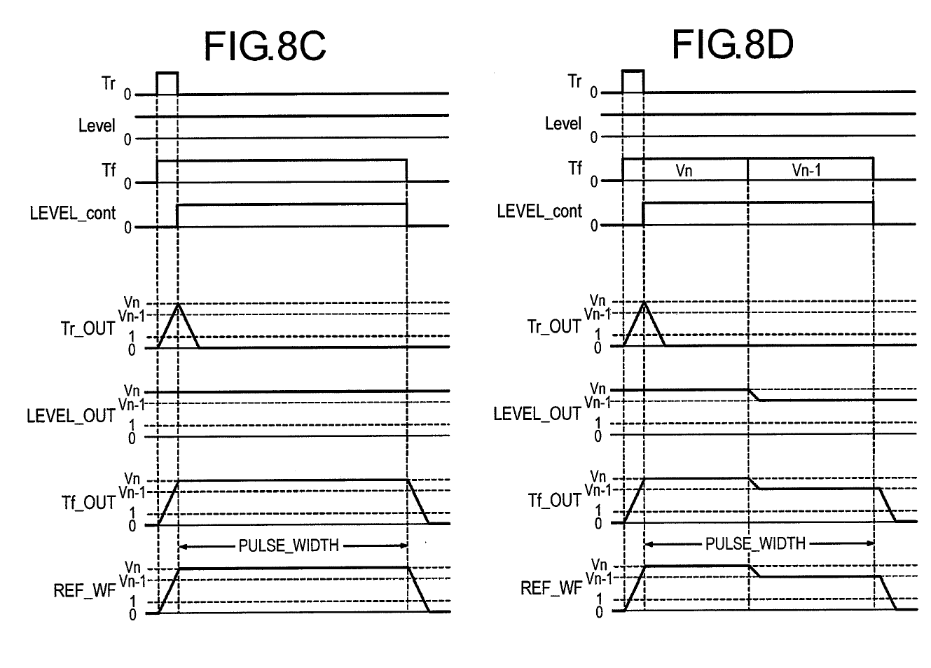

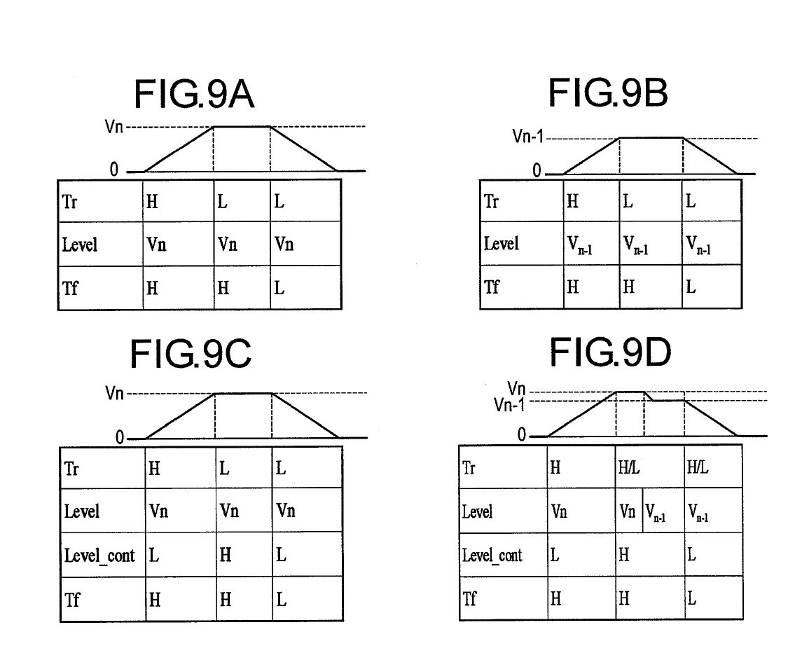

An example of the operation timing of the output circuit A15 according to this embodiment will be explained with reference to FIG. 8A and FIG. 9A. FIG. 8A is a timing chart showing a first operation example of the output circuit A15, and FIG. 9A shows a logical table. The first operation example is a control in which a modulation pulse of a voltage level Vₙ is outputted.

The control signal Level is inputted to the output level generation part A17b, and a voltage level signal LEVEL_OUT is outputted therefrom. In this example, a voltage level Vₙ is outputted.

When the control signal Tr is at a high level, arising waveform Tr_OUT with a fixed inclination or slope is outputted from the rising reference waveform generation part A17a. When the control signal Tr changes to a low level, the rising waveform Tr_OUT becomes 0 V (ground level) after the electric charge charged in the capacitance Ctr has been discharged.

When the control signal Tf is at a high level, the falling reference waveform generation part A17c takes in a voltage of REF_WF. Until the time when the control signal Tf becomes a low level, the falling reference waveform generation part A17c continues to take in the voltage of REF_WF, and outputs that voltage as the output voltage Tf_OUT. When the control signal Tf becomes a low level, the output voltage Tf_OUT falls from REF_WF at a fixed inclination to become 0 V in due course.

When the control signal Tr becomes a high level, the waveform switching part A17d selects and outputs the reference waveform Tr_OUT outputted from the rising reference waveform generation part A17a. In FIG. 8A, the control signal Tr remains a high level during a period of time until the voltage of the reference waveform Tr_OUT reaches the level of Vₙ.

When the control signal Tr becomes a Low level, the waveform switching part A17d selects and outputs the voltage level signal LEVEL_OUT in cases where the control signal Tf is at a high level. When the control signal Tf becomes a low level, the waveform switching part A17d selects and outputs the output voltage Tf_OUT.

By the above-mentioned operation, the reference waveform REF_WF for an output wave rises from the ground level with a fixed inclination, outputs a specified voltage level, and thereafter falls to the ground level with a fixed inclination.

A period of time PULSE_WIDTH in which an output voltage level is outputted can be controlled by adjusting the high periods of the control signals Tr, Tf. By doing so, the pulse width of the reference waveform REF_WF can be controlled, thus making it possible to generate a waveform output in such a manner that the pulse width thereof is expanded while keeping constant the value of the pulse height.

### Second Operation Example

Another example of the operation timing of the output circuit A15 different from the above-mentioned first example will be explained with reference to FIG. 8B and FIG. 9B. FIG. 8B is a timing chart showing a second operation example of the output circuit A15, and FIG. 9B shows a logical table. The differences of this second operation example from the first operation example are that the voltage of the control signal Level is at a level of Vₙ₋₁ which is lower than the level of Vₙ, and that the high period of the control signal Tr is shorter that that in the first operation example, with the same control as that of the first operation example other than these differences being carried out. With this, it becomes possible to change the value of the pulse height of an output wave.

The above-mentioned first and second operation examples are mutually different from each other in the values of the pulse heights, and they can be suitably made use of for the purpose of color adjustment, the adjustment of gradation control characteristics for each color, etc.

In the following, the independent adjustments of RGB will be described.

The image display apparatus of the present invention obtains the light emission of RGB by causing electrons released from a multi electron source to strike against a surface on which fluorescent substances of individual RGB colors are coated. However, these fluorescent substances are in general different from one another in luminous efficiency for each of RGB colors. For this reason, even if the same amount of emitted electrons (amount of electric charges) is supplied to the fluorescent substances of the individual colors, respectively, the amounts of light emission obtained are not the same. As a consequence, the amounts of light emission for the RGB colors can be made to match one another by setting drive voltage values for individual RGB colors in consideration of luminous efficiencies thereof and performing pulse width modulation with the voltage levels thus set.

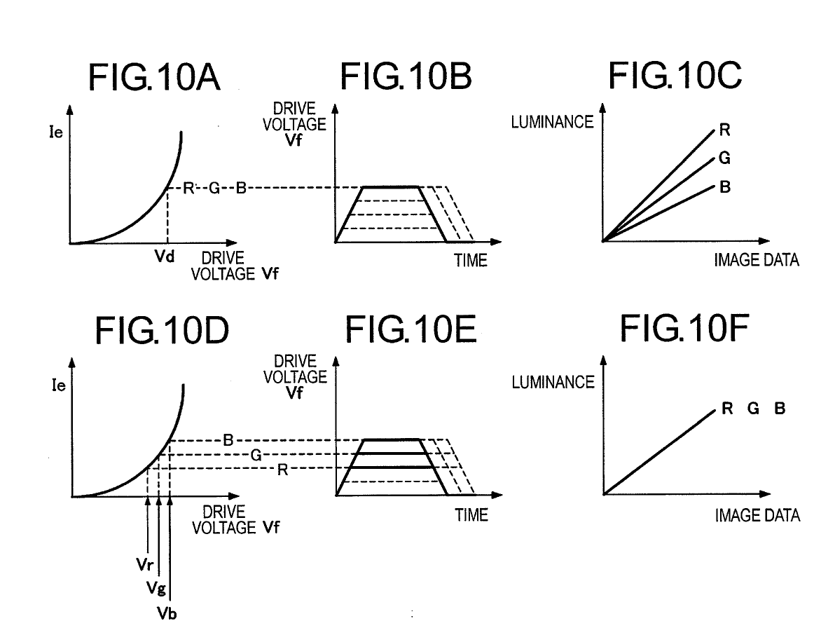

An example will be explained with reference to FIG. 10A through FIG. 10F.

FIG. 10A shows the characteristic of a drive voltage Vf versus an emission current Ie of an electron-emitting device formed in the multi electron source. FIG. 10B shows a driving waveform applied to the electron-emitting device of each of the RGB colors. Here, the same drive voltage Vd is given to each of the RGB colors. FIG. 10C shows the luminance characteristic of each of the RGB colors with respect to image data. In this example, the luminous efficiencies of the fluorescent substances are R>G>B, and it can be seen that when the individual devices of the RGB colors are driven by the same drive voltage, the luminances thereof are different from one another such as R>G>B even if the same image data is given.

Accordingly, as shown in FIG. 10D, the drive voltages for the individual colors are set in such a manner that a drive voltage becomes smaller for an electron-emitting device corresponding to a fluorescent substance with higher luminous efficiency. In the example of FIG. 10D, a drive voltage Vr for R (red color) is set to be smaller than Vd, a drive voltage Vg for G (green color) is set to be equal to Vd, and a drive voltage Vb for B (black color) is set to be larger than Vd. According to this, as shown in FIG. 10E, pulse width modulation is carried out in which the values of the pulse heights (output voltage levels) for the RGB colors are different from one another. By driving the electron-emitting devices by means of such modulation pulses, it is possible to make the luminance characteristics of the RGB colors match with one another, as shown in FIG. 10F.

As described above, it becomes possible to adjust the gradation characteristics for the individual RGB colors by selecting drive voltage values for the individual RGB colors in an appropriate manner, respectively. Here, note that at the time of carrying out nonlinear gradation control such as the adjustment of a gamma characteristic etc., it becomes possible to perform nonlinear gradation control by selecting image data in an appropriate manner.

In addition, in the circuit arrangement of this embodiment, each output circuit A15 is provided with the rising reference waveform generation part A17a, the output level generation part A17b, and the falling reference waveform generation part A17c. Thus, it is possible for each of the output circuits A15 for M pixels to control the rising timing, the voltage level, its output period, and the falling timing of a modulation pulse in an independent manner. In other words, it is possible to change the rising and/or falling timing of the modulation pulse or the voltage level thereof for each pixel (each column wiring).

### Second Embodiment

FIG. 6B is a block diagram showing the circuit arrangement of each reference wave generation circuit A17 according to a second embodiment of the present invention.

The differences of this second embodiment from the first embodiment are that a plurality of reference waveform generation circuits A17 share a common rising reference waveform generation part A17a, and that a control signal LEVEL_cont is provided which specifies the timing at which a voltage level signal LEVEL_OUT is outputted. The second embodiment is the same as the first embodiment other than these. In other words, in this embodiment, the output level generation part A17b, the falling reference waveform generation part A17c, and the waveform switching part A17d are arranged for each column wiring, but the number of the rising reference waveform generation parts A17a is less than the number of the column wirings. In general, the modulation circuit A2 is composed of one or more integrated circuits (IC chips), and a plurality of output circuits A15 are arranged in one integrated circuit. In this embodiment, however, a chip size is able to be decreased by adopting a construction or arrangement in which all the output circuits A15 in the integrated circuit make a common use of the single rising reference waveform generation part A17a. Here, note that the construction of this embodiment can be applied to a control in which the start timing and the operation timing of a rising waveform are constant at all times.

### Third Operation Example

An example of the operation timing of an output circuit A15 according to this embodiment will be explained with reference to FIG. 8C and FIG. 9C. FIG. 8C is a timing chart showing a third operation example of the output circuit A15, and FIG. 9C shows a logical table.

A control signal Level is inputted to the output level generation part A17b, and a voltage level signal LEVEL_OUT of a fixed level is outputted therefrom. In this example, a voltage level Vₙ is outputted, but in the case of voltage levels other than Vₙ, the same operation results.

The control signal LEVEL_cont is a signal which specifies the timing at which the voltage of the voltage level signal LEVEL_OUT is outputted. In the first embodiment, it is possible to select the signal LEVEL_OUT by making low the control signal Tr for each output circuit. However, in cases where common use is made of the rising reference waveform generation part A17a, as in this embodiment, there is a possibility that the timing at which the voltage of the voltage level signal is changed from a rising slope waveform to an output of a constant level may differ from one output circuit to another, so a control signal such as LEVEL_cont is needed.

The operation of the control signal Tr is the same as that of the first embodiment. However, the control signal Tr is used as a timing signal for a plurality of output circuits, so in cases where at least one output circuit is rising, the control signal Tr takes a high level, and then becomes a low level after all the output circuits have risen.

The operation of the control signal Tf is also the same as that of the first embodiment.

The control signal LEVEL_cont is inputted to the waveform switching part A17d. The waveform switching part A17d selects the voltage level signal LEVEL_OUT in cases where the control signal LEVEL_cont is high, and gives priority to the other logics in cases where the control signal LEVEL_cont is low.

In the following, an output operation will be explained. When the control signal Tr becomes a high level, the waveform switching part A17d selects the reference waveform Tr_OUT outputted from the rising reference waveform generation part A17a and outputs a rising waveform thereof. When the control signal LEVEL_cont becomes a high level, the waveform switching part A17d selects the voltage level signal LEVEL_OUT, and outputs a level voltage (Vₙ, here) thereof. When the control signal LEVEL_cont becomes a low level and the control signal Tf becomes a low level, the waveform switching part A17d selects the output voltage Tf_OUT, and outputs a falling waveform thereof.

In this embodiment, the example has been explained in which the output voltage level is Vₙ, but output waveforms of other voltage levels can be generated in a similar manner.

In addition, in the circuit arrangement of this embodiment, each output circuit A15 is provided with the output level generation part A17b, and the falling reference waveform generation part A17c. Thus, it is possible for each of the output circuits A15 for M pixels to control the voltage level, its output period, and the falling timing of a modulation pulse in an independent manner. In other words, it is possible to change the falling timing of the modulation pulse or the voltage level thereof for each pixel (each column wiring).

### Fourth Operation Example

In the above-mentioned first through third operation examples, the voltage level signal LEVEL_OUT is constant, but the voltage level of the voltage level signal LEVEL_OUT can also be changed by changing a specified value of the control signal Level within one horizontal period (1H).

A further example of the operation timing of the output circuit A15 different from the above-mentioned third example will be explained with reference to FIG. 8D and FIG. 9D. FIG. 8D is a timing chart showing a fourth operation example of the output circuit A15, and FIG. 9D shows a logical table.

In the third example, the voltage level signal LEVEL_OUT is at a level of Vₙ at all times during the period when the control signal Level is at a high level, but in contrast to this, in the fourth example, the voltage level signal LEVEL_OUT changes from the level of Vₙ to a level of Vₙ₋₁ in the middle of that period. According to this, it becomes possible to change the output level within one horizontal period (1H).

Although the example has been explained here in which the output level changes from Vₙ to Vₙ₋₁, it is possible to change the output level in an arbitrary manner by controlling the control signal Level. In addition, it is also possible to change the output level in two or more steps within one horizontal period (1H). Moreover, although herein the fourth example has been achieved here by the circuit arrangement of the second embodiment, it is also possible to generate the same modulation pulse waveform by the use of the circuit arrangement of the first embodiment.

(Modification of the Output Stage)

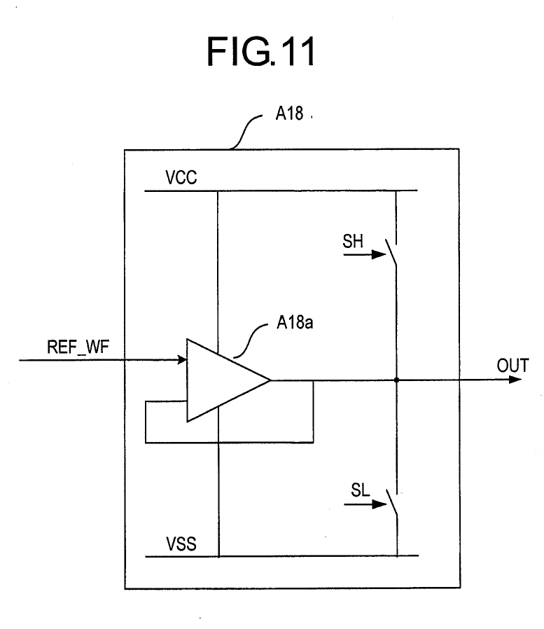

A construction in which a reference waveform is outputted by an amplifier or a buffer is used for the output stage A18 in the above-mentioned embodiments. Here, in cases where outputs of the same voltage levels as power supply voltages are required, switches SH, SL for outputting the power supply voltages may be provided, as shown in FIG. 11. With such a provision, outputs of the same voltage levels as power supply voltages VCC, VSS can be obtained in a stable manner.

Specifically, a rising portion of an output voltage can be caused to rise by means of the operational amplifier A18a, and thereafter, the power supply voltage VCC can be directly outputted by turning on the switch SH. At the time of falling, by turning off the switch SH is turned off and at the same time the voltage has been caused to fully fall by means of the operational amplifier A18a, after which the power supply voltage (reference voltage) VSS can be directly outputted by turning on the switch SL.

### Third Embodiment

A third embodiment of the present invention is intended to increase the peak luminance of an image as much as possible in an image display apparatus using a modulation pulse, as described in the above-mentioned embodiments.

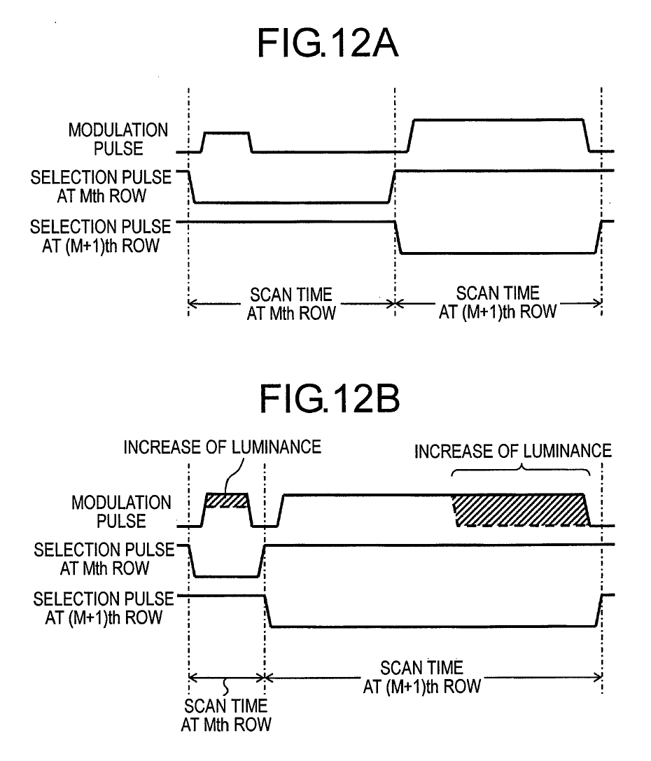

FIG. 12A shows ordinary scan time control used in the first and second embodiments, and FIG. 12B shows variable control of a scan time used in this embodiment. In each of FIG. 12A and FIG. 12B, an upper row indicates a modulation pulse that is outputted to the column wirings, a middle row indicates a selection pulse that is outputted to a row wiring of an Mth row, and a lower row indicates a selection pulse that is outputted to a row wiring of an (M+1)th row. In the ordinary scan time control, the same scan time is assigned to all the row wirings without regard to the time length of the modulation pulse. On the other hand, in this embodiment, peak luminance is intended to be increased by making the length of a scan time variable for each of the row wirings in such a manner that the scan time of a dark line or row is shortened and a long scan time is assigned to a bright line or row. The length of the scan time for each row wiring is set in accordance with a maximum value (being also called a maximum duration period of the modulation pulse) among the time lengths of all the modulation pulses (for one row line) outputted to the column wirings during the time when a selection pulse is outputted to that row wiring. It is assumed that a modulation pulse in FIG. 12B indicates a modulation pulse corresponding to a maximum duration time. In this case, because the maximum duration of a (M+1)th row is longer than that of Mth row, the scan time of the Mth row is shortened and the scan time of the (M+1)th row is extended. Then, according to the extended scan time, image data is enlarged and the pulse width of the modulation pulse is also extended. With respect to other rows, the amplitude or pulse width of the modulation pulse is increased by an amount corresponding to an increase of image data. According to this, an increase in luminance corresponding to a portion indicated by hatching is obtained.

Here, note that such variable control of a scan time is disclosed in detail in Japanese patent application laid-open No. 2006-209152, and basically the same construction as that disclosed in this official patent gazette can also be applied to the image display apparatus of this embodiment, so a detailed description of the circuit arrangement thereof is omitted here.

A study of the present inventors has shown that a method to be described below is optimal to modulation pulses of this embodiment.

In modulation pulses shown in FIG. 2A, FIG. 2C, FIG. 3A and FIG. 3B, the period of a low luminance range (image data 1 to n+1) is a period in which amplitude modulation is carried out and hence a substantially fixed time is required for application of a modulation pulse. In a high luminance range (image data from n+2 onward), the pulse width (time) of a modulation pulse is extended. The modulation pulses used in this embodiment have the features as described above.

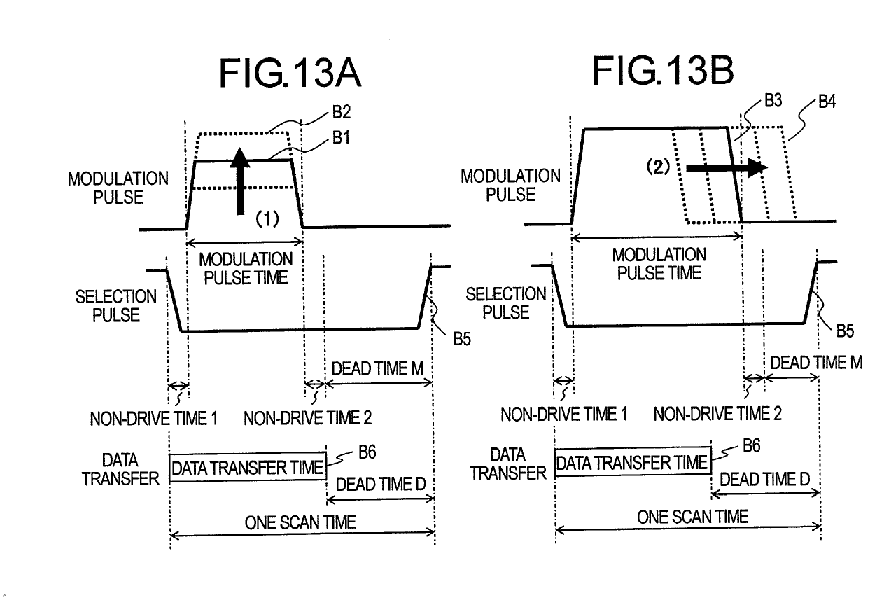

First, ordinary scan time control will be explained by the use of FIG. 13A and FIG. 13B. Here, note that FIG. 13A and FIG. 13B illustrate the modulation pulses of FIG. 2A, but the same can be applied to the case in which modulation pulses other than those of FIG. 2A are used.

In FIG. 13A and FIG. 13B, waveforms in the upper row indicate modulation pulses. In FIG. 13A, modulation pulses (B1, B2) in the low luminance range (image data 1 to n+1) are shown. In the low luminance range (image data 1 to n+1), the modulation pulses do not change in pulse width (to any substantial extent), but increase in an amplitude direction, i.e., in a direction of arrow (1), in accordance with an increase in image data. A modulation pulse for a maximum value (n+1) of image data in the low luminance range is B2, and a modulation pulse for image data exceeding that maximum value becomes to be in the high luminance range. In FIG. 13B, modulation pulses (B2, B3) in the high luminance range (image data from n+2 onward) are shown. In the high luminance range (image data from n+2 onward), the modulation pulses increase in a time direction, i.e., in a direction of arrow (2), in accordance with an increase in image data. A modulation pulse at the time when maximum image data is inputted is indicated by B4.

In FIG. 13A and FIG. 13B, a waveform in the middle row indicates a selection pulse in the ordinary scan time control. In FIG. 13A, a selection pulse (B5) in the low luminance range (image data 1 to n+1) is shown. In FIG. 13B, the selection pulse (B5) in the high luminance range (image data from n+2 onward) is shown. The selection pulse with a pulse width longer than that of the longest modulation pulse (B4) is applied so that even the longest modulation pulse (B4) can be within a period of time in which the row wirings remain at a selection potential. In these figures, “modulation pulse time” is defined as a time corresponding to a lower side length of the modulation pulse.

In line sequential drive in which a selected row wiring is switched in a sequential manner as in the image display apparatus of this embodiment, there is a possibility that an electrical potential change in the row wirings may disturb the waveform of a modulation pulse. Therefore, it is necessary to provide a fixed delay (shift) in the rising timings and falling timings of a selection pulse and a modulation pulse in order to enhance image quality. For this reason, it is desirable to secure a time for switching the electric potential of a row wiring, which is called a “non-drive time”, before the rising and after the falling of the modulation pulse, respectively. The “non-drive time” is the sum total of a time (non-drive time 1) which is an interval from the time when the row wiring becomes the selection potential from a non-selection potential until the time when the modulation pulse becomes possible to be applied to the row wiring, and a time (non-drive time 2) which is an interval from the time when the modulation pulse falls until the time when the electric potential of the row wiring is made to the non-selection potential. Because the “non-drive time” is determined with a margin so that the waveform shape of the modulation pulse can not be disturbed, as stated above, the length of the non-drive time may actually be different from those shown in FIG. 13A and FIG. 13B to a more or less extent.

In the ordinary scan time control, it is designed such that a maximum “modulation pulse time” plus the “non-drive time” becomes equal to one scan time. In other words, the time which is obtained by subtracting the non-drive time from the one scan time (which is automatically determined from the frequency of frames, the number of rows, etc.) becomes the maximum modulation pulse time, by which the peak luminance is decided.

Incidentally, in the low luminance range shown in FIG. 13A, the “modulation pulse time” is short and hence the “modulation pulse time” plus the “non-drive time” is also shorter with respect to the one scan time, so there occurs a “dead or useless time M” which does not contribute to light emission. It can be seen that in the high luminance range, too, the “dead time M” similarly occurs in the case of the modulation pulse (B3) in FIG. 13B. In the modulation pulse (B4) with the longest pulse width, no “dead time M” occurs.

In FIG. 13A and FIG. 13B, a reference symbol B6 denotes the time taken to transfer serialized image data for one row line outputted by the parallel/serial conversion circuit A6 to the modulation circuit A2 (referred to as a “data transfer time”). Of course, this “data transfer time” (B6) is a fixed time without regard to image data. The time taken to actually transfer the data is decided by the speed and the serialization method of circuits, such as ICs or the like, which constitute the parallel/serial conversion circuit A6 and the modulation circuit A2. It is of course designed to be able to transfer the data of all the columns for one row line during the scan time for one row line.

As shown in FIG. 13A and FIG. 13B, the “data transfer time” (B6) is shorter than one scan time, and hence there occurs a time (“dead or useless time D”) in which no image data is transferred, within one scan time. This “dead time D” is a time in which no image data is transferred, so even if the “dead time D” is shortened from the one scan time, there is no influence on the transfer of image data.

In the scan time variable control described in Japanese patent application laid-open No. 2006-209152, the “dead time M” is calculated from a time which is obtained by adding the “non-drive time” to the maximum “modulation pulse time” (“modulation signal maximum duration period”) of all the columns for each row, in view of these conditions. Then, by focusing attention on the shorter one (“dead time”) of the “dead time M” and the “dead time D”, and assigning this shorter “dead time” to the scan time of another row, the “modulation pulse time” of a bright row is made longer thereby to increase the peak luminance of an image. In other words, an excess time with respect to a unit frame time is calculated by totaling, for all the rows, the longer one of the “modulation signal maximum duration period plus non-drive time” and the “data transfer time”. Then, the peak luminance of the image is increased by assigning the excess time (the sum total of “dead times” in unit frames) to the scan time of each row thereby to make “the modulation pulse time” longer.

As a result of the present inventors' repeated studies, it has been found that in such scan time variable control, when the time obtained by adding the “non-drive time” to the “modulation pulse time” in the low luminance range (image data 1 to n+1) is set to a time equal to or less than the “data transfer time”, the effect of more increasing the peak luminance of the image can be obtained. In particular, it has also been found that by making the time, which is obtained by adding the “non-drive time” to the “modulation pulse time” in the low luminance range (image data 1 to n+1), and the “data transfer time” match with each other, the peak luminance of the image can be increased to a maximum extent. The reason for this will be explained below.

The minimum value of a scan time is determined by the longer one of either the “modulation signal maximum duration period plus non-drive time” or the “data transfer time”. In the ordinary pulse width modulation, in cases where image data is small and the pulse width of a modulation pulse is short (in the case of a dark row), the “modulation signal maximum duration period” is short, and hence the scan time is determined by the “data transfer time”. On the contrary, in a bright row in which the “modulation signal maximum duration period plus non-drive time” becomes longer than the “data transfer time”, the assignment of a scan time for the row wiring is determined by the scan time that is decided by the “modulation signal maximum duration period plus non-drive time”. Of course, the smaller the excess time, the smaller the effect of increasing the peak luminance of an image becomes.

In the case of the modulation pulse of this embodiment, even if image data is for a first gradation level, the same “modulation pulse time” as that for a (n+1)th gradation level is required, since an amplitude modulation is performed in the low luminance range. For this reason, even in the case of a dark row, unless image data for all the columns have zero gradation, the “modulation signal maximum duration period” becomes to be a long “modulation pulse time” corresponding to image data (n+1). In cases where the “modulation pulse time plus non-drive time” in the low luminance range (image data 1 to n+1) is longer than the “data transfer time”, the “data transfer time” determines the scan time for the zeroth gradation, but from the first gradation onward, the “modulation pulse time plus non-drive time” determines the scan time. That is, from the first gradation, an excess time for the scan time becomes smaller, so the effect of increasing the peak luminance of an image is reduced.

Accordingly, in this embodiment, when the data transfer time is set to T1 and the non-drive time is set to T2, the “modulation pulse time” in the low luminance range (image data 1 to n+1) for performing amplitude modulation is set to be “equal to or less than T1−T2”. As a result of this, the excess time can be secured to the utmost extent, so the assignment of a scan time to a bright row (a line including image data in the high luminance range) can be increased, whereby the peak luminance of an image can be increased to a maximum level. In particular, it is desirable to set the “modulation pulse time” in the low luminance range (image data 1 to n+1) in such a manner that the “modulation pulse time” becomes equal to “T1−T2”. According to this, a waste of scan time can be decreased to a minimum level, and the scan time can be assigned in the most efficient manner.

As explained above, according to the scan time variable control of this embodiment, in a modulation method of increasing the pulse height of a trapezoidal shape pulse in the low luminance range, and thereafter making longer the pulse width of the trapezoidal shape pulse, it becomes possible to display an image of good quality with increased peak luminance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-137160, filed on Jun. 8, 2009, and Japanese Patent Application No. 2010-009676, filed on Jan. 20, 2010, which are hereby incorporated by reference herein in their entirety.

What is claimed is:

1. A control method for an image display apparatus with a display panel in which a plurality of display elements are arranged in an matrix arrangement using a plurality of column wirings and a plurality of row wirings, the method comprising the steps of:
outputting a selection potential to a row wiring to be driven; and
generating a modulation pulse based on a value of image data, and outputting the modulation pulse to the column wiring, wherein
when I is a value of the image data, Imin is a minimum value of I, Imax is a maximum value of I, and Imin<I1<I2≦Imax,
the step of generating and outputting the modulation pulse
generates, in a range of Imin≦I≦I1, a trapezoidal shape pulse as the modulation pulse, and makes the pulse height of the trapezoidal shape pulse larger in accordance with the increasing of the value I; and
makes, in the range of I1<I≦I2, the pulse width of the trapezoidal shape pulse longer in accordance with the increasing of the value I.

2. The control method for an image display apparatus according to claim 1, wherein
the step of generating and outputting the modulation pulse makes, in the range of Imin≦I≦I1, the pulse height of the trapezoidal shape pulse larger in accordance with the increasing of the value I, while keeping constant a lower side length or an upper side length of the trapezoidal shape pulse.

3. The control method for an image display apparatus according to claim 1, wherein
the step of generating and outputting the modulation pulse makes, in the range of I1<I≦I2, the pulse width of the trapezoidal shape pulse longer in accordance with the increasing of the value I, while keeping constant the pulse height of the trapezoidal shape pulse.

4. The control method for an image display apparatus according to claim 1, wherein
in the step of generating and outputting the modulation pulse, the trapezoidal shape pulse is generated by combining a first waveform rising in a slope shape, a second waveform specifying the pulse height, and a third waveform falling in a slope shape, with one another.

5. The control method for an image display apparatus according to claim 4, wherein
an inclination of the first waveform is the same for all the values of the image data.

6. The control method for an image display apparatus according to claim 4, wherein
an inclination of the third waveform is the same for all the values of the image data.

7. The control method for an image display apparatus according to claim 1, wherein
when I2<I3≦Imax, the step of generating and outputting the modulation pulse
generates, in the range of I2<I≦I3, a substantially trapezoidal shape pulse as the modulation pulse, which rises in a slope shape up to a pulse height h1, maintains the pulse height h1 in a period of time t1, falls in a slope shape down to a pulse height h2, maintains the pulse height h2 in a period of time t2, and falls in a slope shape; and
makes the period of time t2 of the substantially trapezoidal shape pulse longer in accordance with the increasing of the value I.

8. The control method for an image display apparatus according to claim 7, wherein
when I3<I4≦Imax, the step of generating and outputting the modulation pulse
generates, in the range of I3<I≦I4, a substantially trapezoidal shape pulse as the modulation pulse, which rises in a slope shape up to the pulse height h1, maintains the pulse height h1 in the period of time t1, falls in a slope shape down to the pulse height h2, maintains the pulse height h2 in the period of time t2, falls in a slope shape down to a pulse height h3, maintains the pulse height h3 in a period of time t3, and falls in a slope shape; and
makes the period of time t3 of the substantially trapezoidal shape pulse longer in accordance with the increasing of the value I.

9. The control method for an image display apparatus according to claim 1, wherein
when I2<I5≦Imax, the step of generating and outputting the modulation pulse generates, in the range of I2<I≦I5, a second trapezoidal shape pulse as the modulation pulse, which is larger than a trapezoidal shape pulse corresponding to I=I2, and makes the pulse height of the second trapezoidal shape pulse larger in accordance with the increasing of the value I.

10. The control method for an image display apparatus according to claim 9, wherein
when I5<I6≦Imax, the step of generating and outputting the modulation pulse makes, in the range of I5<I≦I6, the pulse width of the second trapezoidal shape pulse longer in accordance with the increasing of the value I.

11. The control method for an image display apparatus according to claim 1, wherein
the length of a scan time, which is a period of time during which a selection potential is outputted, is variable for each row wiring; and
the length of the scan time for each row wiring is set in accordance with a maximum value among the time lengths of all the modulation pulses outputted to the plurality of column wirings during the time when a selection potential is outputted to that row wiring.

12. The control method for an image display apparatus according to claim 11, wherein
the length of the modulation pulse in the range of Imin≦I≦I1 is set to be equal to or less than a value of T1−T2,
where T1 is the time taken to transfer image data for one row line to a modulation circuit, which generates modulation pulses based on the image data, and
T2 is the sum total of times, which should be secured at least before the rising and after the falling of the modulation pulse so as to switch the electric potential of the row wiring.
